(19) United States
(12) Patent Application Publication
(10) Pub. No.: US 2025/0376547 A1
(43) Pub. Date: Dec. 11, 2025

(54) CONTINUOUS OLEFIN POLYMERIZATION PROCESS IN THE PRESENCE OF AN ANTISTATIC AGENT

(71) Applicant: Basell Polyolefine GmbH, Wesseling (DE)

(72) Inventors: Giulia Mei, Ferrara (IT); Gabriele Mei, Ferrara (IT); Antonio Mazzucco, Ferrara (IT); Lorella Marturano, Ferrara (IT); Tiziana Caputo, Ferrara (IT); Paolo Capisani, Ferrara (IT); Stefano Sessa, Ferrara (IT); Pietro Baita, Ferrara (IT); Gerhardus Meier, Frankfurt/M (DE); Ulf Schueller, Frankfurt/M (DE); Sebastian Wilhelm, Frankfurt/M (DE)

(73) Assignee: Basell Polyolefine GmbH, Wesseling (DE)

(21) Appl. No.: 19/107,909

(22) PCT Filed: Sep. 8, 2023
(86) PCT No.: PCT/EP2023/074696

§ 371 Date: Feb. 28, 2025

(30) Foreign Application Priority Data
Sep. 9, 2022 (EP) 22194791.4

(51) Int. Cl. C08F 2/44; C08F 2/01; C08F 2/34; C08F 10/02

(52) U.S. Cl. CPC C08F 2/44; C08F 2/01; C08F 2/34; C08F 10/02; C08F 2400/02

(57) ABSTRACT

A process for the continuous production of a polyolefin polymer in a gas-phase polymerization reactor in the presence of a polymerization catalyst and an antistatic agent, including the steps of (a) providing a mixture of polyolefin particles and gas, (b) conveying the mixture through a pipe at a gas velocity of greater than or equal to 2 m/s, and (c) introducing an antistatic agent into the mixture.

### FIELD OF THE DISCLOSURE

In general, the present disclosure relates to the field of chemistry. More specifically, the present disclosure relates to polymer chemistry. In particular, the present disclosure relates to a process for the continuous production of a polyolefin polymer in a gas-phase polymerization reactor in the presence of a polymerization catalyst and an antistatic agent.

### BACKGROUND OF THE DISCLOSURE

In some instances and during production of polymers, the polymer particles show a tendency to stick to the reactor walls. In some instances, it is believed that the cause is electrostatic charges. In some instances, the polymer particles form chunks or wall sheeting, thereby plugging the polymerization reactor and leading to a shut-down of the polymerization reactor. In some instances, the sticking polymer particles also obstruct the fluid-dynamics in the reactor and disturb fluidization.

In some instances, antistatic agents are used in the polymerization of olefins, thereby avoiding electrostatic charging and reducing wall sheeting and the formation of polymer agglomerates in the polymerization reactor or in downstream equipment. In some instances, the downstream equipment includes degassing and recovery vessels. In some instances and in the context of polyolefin polymerization, antistatic agents are also referred to as antifouling agents, polymerization process aids, activity inhibitors or kinetic modifiers. In some instances, the antistatic agent is made from or containing antistatically-acting compounds, having polar functional groups. In some instances, the polar functional groups are acid or ester groups, amine or amide groups, or hydroxyl or ether groups. In some instances, the antistatically-acting compounds are selected from the group consisting of polysulfone copolymers, polymeric polyamines, polyalcohols, hydroxyesters of polyalcohols, salts of alkylarylsulfonic acids, polysiloxanes, alkoxyamines, and polyglycol ethers.

In some instances and in multizone circulating reactors, polymer particles adhere to the walls of the riser and coverage of the wall of the riser is continuously built up. In some instances, these agglomerated polymer particles drop at a certain point; the amount of transportable polymer particles in the riser increases abruptly; more polymer is transported to the downcomer; the polymer particle level within the downcomer rises very fast. In some instances, the density of the reactor content in the riser changes temporarily and the fluid-dynamics of the reaction mixture fluctuate. Moreover, the variation of the polymer particle level within the downcomer also influences the fluid-dynamics within the whole multizone circulating reactor. It is believed that the efficacy of antistatic agents is dependent dispersion over the polymer powder.

In some instances, antistatic agents used in the continuous polymerization of olefins have an antistatic effect and negatively impact the activity of olefin polymerization catalysts. In some instances, these antistatic agents do not fully prevent sheeting and lump formation from electrostatic charging. In some instances, the prevention is limited when preparing polyolefins with relatively high molecular weights.

### SUMMARY OF THE DISCLOSURE

In a general embodiment, the present disclosure provides a process for the continuous production of a polyolefin polymer in a gas-phase polymerization apparatus at temperatures from 20 to 200° C. and pressures from 0.5 to 10 MPa in the presence of a polymerization catalyst, including the steps of:
providing a mixture of polyolefin particles and gas;
conveying the mixture through a pipe at a gas velocity of greater than or equal to 2 m/s; and
introducing an antistatic agent into the mixture.

In some embodiments, the mixture is conveyed through the pipe at a gas velocity of less than or equal to 50 m/s, alternatively less than or equal to 40 m/s, alternatively less than or equal to 30 m/s; alternatively less than or equal to 20 m/s.

In some embodiments, the density of the polyolefin particles in the gas is at least 30 kg/m³, alternatively at least 50 kg/m³, alternatively at least 80 kg/m³. In some embodiments, the density of the polyolefin particles in the gas is less than or equal to 200 kg/m³.

In some embodiments, the pipe is a discharge line, a transfer line, or both.

In some embodiments, the process further includes the steps of:
feeding an olefin or an olefin and one or more other ethylenically unsaturated monomers into a gas-phase polymerization reactor;
homopolymerizing the olefin or copolymerizing the olefin and the one or more other ethylenically unsaturated monomer in the gas-phase reactor in the presence of a polymerization catalyst, thereby forming polyolefin particles; and
discharging the formed polyolefin particles from the gas-phase reactor.

In some embodiments, the gas-phase polymerization apparatus includes two or more gas-phase polymerization reactors. In some embodiments, the gas-phase polymerization apparatus includes a sequence of a fluidized bed reactor and a multi zone circulating reactor.

In some embodiments, the antistatic agent is made from or containing an alkylene oxide derived polymer. In some embodiments, the alkylene oxide derived polymer is made from or containing in average from 10 to 200 —(CH₂—CHR—O)— with R being hydrogen or an alkyl group having from 1 to 6 carbon atoms, wherein the alkylene oxide derived polymer is a random copolymer of ethylene oxide and other alkylene oxides and a ratio n:m of repeating units —(CH₂—CHR—O)— derived from ethylene oxide to repeating units-(CH2-CHR'-O)-derived from the other alkylene oxides with R′ being an alkyl group having from 1 to 6 carbon atoms is in the range of from 6:1 to 1:1, and the end groups of the alkylene oxide derived polymer are —OH groups.

In some embodiments, the alkylene oxide derived polymer is a random copolymer of ethylene oxide and propylene oxide. In some embodiments, the alkylene oxide derived polymer is a linear ethylene oxide/propylene oxide copolymer.

In some embodiments, the antistatic agent is introduced into the mixture of gas and polyolefin in a feed of a carrier, wherein the weight ratio of antistatic agent to carrier in the combined stream introduced into the pipe is in the range from 1:5000 to 1:10. In some embodiments, the carrier is liquid carrier.

In some embodiments, the carrier is selected from the group consisting of water and liquid hydrocarbons. In some embodiments, the liquid hydrocarbons have from 3 to 8 carbon atoms. In some embodiments, the liquid hydrocarbon is propane.

In some embodiments, the polymerization is carried out in a polymerization reactor cascade including a fluidized-bed reactor and a multizone circulating reactor, wherein, in the multizone circulating reactor, the growing polymer particles flow upward through a first polymerization zone (also referred to herein as the “riser”) under fast fluidization or transport conditions, leave the first polymerization zone, enter a second polymerization zone (also referred to herein as the “downcomer”) through which the particles flow downward under the action of gravity, leave the downcomer, and are reintroduced into the riser, thereby establishing a circulation of polymer. In some embodiments, the fluidized-bed reactor is arranged upstream of the multizone circulating reactor.

In some embodiments, a comparatively lower molecular weight polyolefin polymer component is obtained in the fluidized-bed reactor and a comparatively higher molecular weight polyolefin polymer component is obtained in the multizone circulating reactor.

In some embodiments, the polyolefin polymer is a polyethylene prepared by homopolymerizing ethylene or copolymerizing ethylene and up to 10 wt. %, alternatively up to 5 wt. %, alternatively up to 3 wt. %, of C₃-C₈-1-alkenes.

In some embodiments, the present disclosure provides a gas-phase polymerization apparatus for carrying out the process, including a gas-phase polymerization reactor and at least one pipe, having at least one inlet for introducing an antistatic agent into the pipe. In some embodiments, the antistatic agent is fed into the gas-phase polymerization reactor and the pipe.

In some embodiments, the pipe has a receiving end for receiving a mixture of polyolefin particles and gas and a discharge end for discharging a mixture of polyolefin particles and gas, wherein the inlet for introducing an antistatic agent into the pipe is located within the first half of the pipe. In some embodiments, the inlet is arranged within the first third of the pipe from the receiving end of the pipe.

### BRIEF DESCRIPTION OF THE DRAWINGS

FIG. 1 shows a schematic of a polymerization reactor cascade including a fluidized-bed reactor and a multizone circulating reactor.

### DETAILED DESCRIPTION OF THE DISCLOSURE

In some embodiments, the present disclosure provides a continuous process for the production of a polyolefin. In some embodiments, the process is for the polymerization of 1-olefins, that is, hydrocarbons having terminal double bonds, without being restricted thereto. In some embodiments, monomers are functionalized olefinically unsaturated compounds. In some embodiments, the functionalized olefinically unsaturated compounds are ester or amide derivatives of acrylic or methacrylic acid. In some embodiments, the functionalized olefinically unsaturated compounds are acrylates, methacrylates, or acrylonitrile. In some embodiments, the monomers are nonpolar olefinic compounds. In some embodiments, the nonpolar olefinic compounds include aryl-substituted 1-olefins. In some embodiments, the 1-olefins are linear C₂-C₁₂-1-alkenes, branched C₂-C₁₂-1-alkenes, conjugated and nonconjugated dienes, or vinylaromatic compounds. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched C₂-C₁₀-1-alkene is 4-methyl-1-pentene. In some embodiments, the dienes are selected from the group consisting of 1,3-butadiene, 1,4-hexadiene, and 1,7-octadiene. In some embodiments, the vinylaromatic compounds are styrene or substituted styrene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized.

In some embodiments, the process is for the homopolymerization or copolymerization of ethylene or propylene. In some embodiments, the process is for the homopolymerization or copolymerization of ethylene. In some embodiments, comonomers in propylene polymerization are up to 40 wt. % of ethylene, 1-butene, or both, alternatively from 0.5 wt. % to 35 wt. % of ethylene, 1-butene, or both, based on the total weight of monomers and comonomers. In some embodiments, comonomers in ethylene polymerization are up to 20 wt. %, alternatively from 0.01 wt. % to 15 wt. %, alternatively from 0.05 wt. % to 12 wt. %, of C₃-C₈-1-alkenes, based on the total weight of monomers and comonomers. In some embodiments, the C₃-C₈-1-alkenes are selected from the group consisting of 1-butene, 1-pentene, 1-hexene, and 1-octene. In some embodiments, ethylene is copolymerized with from 0.1 wt. % to 12 wt. % of 1-hexene, 1-butene, or both, based on the total weight of monomers and comonomers.

In some embodiments, the polymerization of olefins is carried out in the presence of a polymerization catalyst. In some embodiments, the polymerization is carried out using Phillips catalysts based on chromium oxide, using titanium-based Ziegler- or Ziegler-Natta-catalysts, or using single-site catalysts. As used herein, single-site catalysts are catalysts based on chemically uniform transition metal coordination compounds. In some embodiments, mixtures of two or more of these catalysts are used for the polymerization of olefins. In some embodiments, mixed catalysts are referred to as hybrid catalysts.

In some embodiments, the catalysts are of the Phillips type. In some embodiments, the catalysts of the Phillips type are prepared by applying a chromium compound to an inorganic support and subsequently calcinating the supported chromium compound at temperatures in the range from 350 to 950° C. thereby converting chromium present in valences lower than six into the hexavalent state. In some embodiments, further elements are selected from the group consisting of magnesium, calcium, boron, aluminum, phosphorus, titanium, vanadium, zirconium, and zinc. In some embodiments, the further elements are selected from the group consisting of titanium. zirconium, and zinc. In some embodiments, combinations of the elements are used. In some embodiments, the catalyst precursor is doped with fluoride prior to or during calcination. In some embodiments, supports for Phillips catalysts are made from or containing aluminum oxide, silicon dioxide (silica gel), titanium dioxide, zirconium dioxide or their mixed oxides or cogels, or aluminum phosphate. In some embodiments, the support materials are obtained by modifying the pore surface area. In some embodiments, the pore surface area is modified by compounds of the element boron, aluminum, silicon or phosphorus. In some embodiments, the support material is a silica gel. In some embodiments, the silica gels are spherical or granular silica gels. In some embodiments, the spherical silica gels are spray dried. In some embodiments, the activated chromium catalysts are subsequently prepolymerized or prereduced. In some embodiments, the prereduction is carried out with cobalt. In some embodiments, the prereduction is carried out with hydrogen at 250 to 500° C. alternatively at 300 to 400° C. In some embodiments, the prereduction is carried out in an activator.

In some embodiments, the catalysts are single-site catalysts. In some embodiments, the single-site catalysts are made from or containing bulky sigma- or pi-bonded organic ligands, for example, catalysts based on mono-Cp complexes, catalysts based on bis-Cp complexes, or catalysts based on late transition metal complexes. In some embodiments, embodiments, catalysts based on bis-Cp complexes are designated as metallocene catalysts. In some embodiments, catalysts based on late transition metal complexes have the complexes as iron-bisimine complexes. In some embodiments, the catalysts are mixtures of two or more single-site catalysts or mixtures of different types of catalysts made from or containing at least one single-site catalyst.

In some embodiments, the catalysts are of the Ziegler type. In some embodiments, the catalysts are made from or containing a compound of titanium or vanadium, a compound of magnesium, and optionally an electron donor compound, a particulate inorganic oxide as support, or both. In some embodiments, the catalysts are of the Ziegler type are used in combination with an antistatic agent. In some embodiments, the antistatic agent is made from or containing a copolymer of ethylene oxide and propylene oxide.

In some embodiments, the titanium compounds are made of the halides or alkoxides of trivalent or tetravalent titanium. In some embodiments, the titanium compounds are titanium alkoxy halogen compounds or mixtures of various titanium compounds. In some embodiments, the titanium compounds are selected from the group consisting of TiBr₃, TiBr₄, TiCl₃, TiCl₄, Ti(OCH₃)Cl₃, Ti(OC₂H₅)Cl₃, Ti(O-i-C₃H₇)Cl₃, Ti(O-n-C₄H₉)C|₃, Ti(OC₂H₅)Br₃, Ti(O-n-C₄H₉)Br₃, Ti(OCH₃)₂Cl₂, Ti(OC₂H₅)₂C|₂, Ti(O-n-C₄H₉)₂C|₂, Ti(OC₂H₅)₂Br₂, Ti(OCH₃)₃Cl, Ti(OC₂H₅)₃Cl, Ti(O-n-C₄H₉)₃Cl, Ti(OC₂H₅)₃Br, Ti(OCH₃)₄, Ti(OC₂H₅)₄, and Ti(O-n-C₄H₉)₄. In some embodiments, the titanium compounds have chlorine as the halogen. In some embodiments, the titanium compounds are titanium halides consisting of halogen and titanium. In some embodiments, the titanium compounds are titanium chlorides. In some embodiments, the titanium compounds are titanium tetrachloride. In some embodiments, the vanadium compounds are selected from the group consisting of vanadium halides, vanadium oxyhalides, vanadium alkoxides, and vanadium acetylacetonates. In some embodiments, the vanadium compounds are vanadium compounds in the oxidation states 3 to 5.

In some embodiments, at least one compound of magnesium is used in the production of the solid component. In some embodiments, the magnesium compounds are halogen-comprising magnesium compounds, alternatively magnesium halides. In some embodiments, the halides are chlorides or bromides. In some embodiments, the magnesium halides are obtained by reaction with halogenating agents. In some embodiments, halogens are chlorine, bromine, iodine or fluorine or mixtures of two or more halogens. In some embodiments, the halogens are chlorine or bromine, alternatively chlorine.

In some embodiments, halogen-comprising magnesium compounds are magnesium chlorides or magnesium bromides. In some embodiments, halogen-comprising magnesium compounds are prepared from magnesium compounds selected from the group consisting of magnesium alkyls, magnesium aryls, magnesium alkoxy compounds, magnesium aryloxy compounds, and Grignard compounds. In some embodiments, halogenating agents are selected from the group consisting of halogens, hydrogen halides, SiCl₄, and CCl₄. In some embodiments, halogenating agents are chlorine or hydrogen chloride.

In some embodiments, halogen-free compounds of magnesium are selected from the group consisting of diethylmagnesium, di-n-propylmagnesium, diisopropylmagnesium, di-n-butylmagnesium, di-sec-butylmagnesium, di-tert-butylmagnesium, diamylmagnesium, n-butylethylmagnesium, n-butyl-sec-butylmagnesium, n-buty loctylmagnesium, diphenylmagnesium, diethoxymagnesium, di-n-propyloxy magnesium, diisopropyloxymagnesium, di-n-buty loxymagnesium, di-sec-butyloxymagnesium, di-tert-butyloxy-magnesium, diamyloxymagnesium, n-butyloxyethoxymagnesium, n-butyloxy-sec-butyloxy-magnesium, n-butyloxyoctyloxymagnesium and diphenoxymagnesium. In some embodiments, halogen-free compounds of magnesium are n-butylethylmagnesium or n-butyloctylmagnesium.

In some embodiments. Grignard compounds are selected from the group consisting of methylmagnesium chloride, ethylmagnesium chloride, ethylmagnesium bromide, ethylmagnesium iodide, n-propylmagnesium chloride, n-propylmagnesium bromide, n-butylmagnesium chloride, n-butylmagnesium bromide, sec-butylmagnesium chloride, sec-butylmagnesium bromide, tert-butylmagnesium chloride, tert-butylmagnesium bromide, hexylmagnesium chloride, octylmagnesium chloride, amyl-magnesium chloride, isoamylmagnesium chloride, phenylmagnesium chloride and phenyl-magnesium bromide.

In some embodiments, magnesium compounds for producing the particulate solids are selected from the group consisting of magnesium dichloride, magnesium dibromide, and di(C₁-C₁₀-alky)magnesium compounds. In some embodiments, magnesium compounds for producing the particulate solids are di(C₁-C₁₀-alky) magnesium compounds. In some embodiments, the Ziegler-Natta catalyst is made from or containing a transition metal selected from the group consisting of titanium, zirconium, vanadium, and chromium.

In some embodiments, electron donor compounds for preparing Ziegler type catalysts are selected from the group consisting of alcohols, glycols, esters, ketones, amines, amides, nitriles, alkoxysilanes and aliphatic ethers. In some embodiments, the electron donor compounds are used alone or in mixtures with other electron donor compounds.

In some embodiments, alcohols have the formula R¹OH, wherein the R¹ group is a C₁-C₂₀ hydrocarbon group. In some embodiments, R¹ is a C₁-C₂₀-alkyl group. In some embodiments, the alcohols are selected from the group consisting of methanol, ethanol, iso-propanol and n-butanol. In some embodiments, the glycols have a total number of carbon atoms lower than 50. In some embodiments, the glycols are 1,2 or 1,3 glycols, having a total number of carbon atoms lower than 25. In some embodiments, the glycol is selected from the group consisting of ethylene glycol, 1,2-propylene glycol and 1,3-propylene glycol. In some embodiments, esters are the alkyl esters of C₁-C₂₀ aliphatic carboxylic acids, alternatively C₁-C₈-alkyl esters of aliphatic mono carboxylic acids. In some embodiments, the C₁-C₈-alkyl esters of aliphatic mono carboxylic acids are selected from the group consisting of ethylacetate, methyl-formiate, ethylformiate, methylacetate, propylacetate, i-propylacetate, n-butylacetate, and i-butyl-acetate. In some embodiments, amines have the formula NR²₃, wherein the R² groups are, independently, hydrogen or a C₁-C₂₀-hydrocarbon group with the proviso that the R² groups are not simultaneously hydrogen. In some embodiments. R² is a C₁-C₁₀ alkyl group. In some embodiments, amines are selected from the group consisting of diethylamine, diiso-propylamine and triethylamine. In some embodiments, the amides have the formula R³CONR⁴₂, wherein R³ and R⁴ are, independently, hydrogen or a C₁-C₂₀ hydrocarbon group. In some embodiments, the amides are selected from the group consisting of formamide and acetamide. In some embodiments, the nitriles have the formula R¹CN, wherein R¹ is a C₁-C₂₀ hydrocarbon group. In some embodiments. R¹ is a C₁-C₂₀-alkyl group. In some embodiments, the nitrile is acetonitrile. In some embodiments, alkoxysilanes have the formula R⁵ₐR⁶_{b}Si(OR⁷)_{c}, wherein a and b are integer from 0 to 2, c is an integer from 1 to 4 and the sum (a+b+c) is 4; R⁵, R⁶, and R⁷, are alkyl, cycloalkyl or aryl radicals with 1-1 8 carbon atoms optionally containing heteroatoms. In some embodiments, the silicon compounds have a is 0 or 1, c is 2 or 3, R⁶ is an alkyl or cycloalkyl group, optionally containing heteroatoms, and R⁷ is methyl. In some embodiments, the silicon compounds are selected from the group consisting of methyltrimethoxysilane, dimethyldimethoxysilane, trimethylmethoxysilane and 1-butyltrimethoxysilane. In some embodiments, electron donor compounds are selected from the group consisting of amides, esters, and alkoxysilanes.

In some embodiments, catalysts of the Ziegler type are polymerized in the presence of a cocatalyst. In some embodiments, the cocatalysts are organometallic compounds of metals of groups 1, 2, 12, 13 or 14 of the Periodic Table of Elements, alternatively organometallic compounds of metals of group 13, alternatively organoaluminum compounds. In some embodiments, the cocatalysts are organometallic alkyls, organometallic alkoxides, or organometallic halides. In some embodiments, organometallic compounds are selected from the group consisting of lithium alkyls, magnesium alkyls, zinc alkyls, magnesium alkyl halides, aluminum alkyls, silicon alkyls, silicon alkoxides and silicon alkyl halides. In some embodiments, the organometallic compounds are selected from the group consisting of aluminum alkyls and magnesium alkyls. In some embodiments, the organometallic compounds are aluminum alkyls. In some embodiments, the organometallic compounds are trialkylaluminum compounds. In some embodiments, the aluminum alkyls are selected from the group consisting of trimethyl-aluminum, triethylaluminum, tri-iso-butylaluminum, and tri-n-hexylaluminum.

In some embodiments, the resulting polyolefin particles have a regular morphology and size, which depend on the catalyst morphology, the catalyst size, and polymerization conditions. In some embodiments and depending on the catalyst used, the polyolefin particles have a mean diameter of from a few hundred to a few thousand micrometers. In some embodiments and with chromium catalysts, the mean particle diameter is from about 300 to about 1600 μm. In some embodiments and with Ziegler type catalysts, the mean particle diameter is from about 500 to about 3000 μm.

In some embodiments, the process is carried out as gas-phase polymerization, that is, by a process wherein the solid polymers are obtained from a gas-phase of the monomer or the monomers. In some embodiments, the gas-phase polymerizations are carried out at pressures of from 0.1 to 20 MPa, alternatively from 0.5 to 10 MPa, alternatively from 1.0 to 5 MPa. In some embodiments, the polymerization temperatures are from 40 to 150° C. alternatively from 65 to 125° C.

In some embodiments, the process is carried out in an apparatus including two or more gas-phase polymerization reactors. In some embodiments, the reactors include a sequence of a fluidized bed reactor and a multizone circulating reactor.

Fluidized-bed polymerization reactors are reactors, wherein the polymerization takes place in a bed of polymer particles maintained in a fluidized state by feeding in gas at the lower end of a reactor and taking off the gas again at the upper end of the reactor. In some embodiments, the gas is fed below a gas distribution grid, having the function of dispensing the gas flow. The reactor gas is then returned to the lower end of the reactor via a recycle line equipped with a compressor and a heat exchanger. In some embodiments, the circulated reactor gas is a mixture of the olefins to be polymerized, inert gases, and optionally a molecular weight regulator. In some embodiments, the inert gases are selected from the group consisting of nitrogen and lower alkanes. In some embodiments, the lower alkanes are selected from the group consisting of ethane, propane, butane, pentane, and hexane. In some embodiment, the molecular weight regulator is hydrogen. In some embodiments, the inert gas is nitrogen or propane. In some embodiments, the inert gas is nitrogen or propane in combination with further lower alkanes. In some embodiments, the velocity of the reactor gas fluidizes the mixed bed of finely divided polymer present in the tube serving as polymerization zone and removes the heat of polymerization. In some embodiments, the polymerization is carried out in a condensed or super-condensed mode, wherein part of the circulating reaction gas is cooled to below the dew point and returned to the reactor (a) separately as a liquid and a gas or (b) together as a liquid-gas phase mixture, thereby making additional use of the enthalpy of vaporization for cooling the reaction gas.

Multizone circulating reactors are gas-phase reactors, wherein two polymerization zones are linked to each another and the polymer is passed alternately, a plurality of times, through these two zones. In some embodiments, the reactors are as described in Patent Cooperation Treaty Publication Nos. WO 97/04015 A1 and WO 00/02929 A1. In some embodiments, the reactors have two interconnected polymerization zones, a riser, wherein the growing polymer particles flow upward under fast fluidization or transport conditions and a downcomer, wherein the growing polymer particles flow in a densified form under the action of gravity. The polymer particles leaving the riser enter the downcomer, and the polymer particles leaving the downcomer are reintroduced into the riser, thereby establishing a circulation of polymer between the two polymerization zones. In some embodiments, the polymer is passed alternately a plurality of times through these two zones. In some embodiments, the two polymerization zones of a multizone circulating reactor are operated with different polymerization conditions by establishing different polymerization conditions in the riser and the downcomer. In some embodiments and for this purpose, the gas mixture leaving the riser and entraining the polymer particles is partially or totally prevented from entering the downcomer. In some embodiments, a barrier fluid in form of a gas or a liquid mixture is fed into the downcomer. In some embodiments, the barrier fluid is fed in the upper part of the downcomer. In some embodiments, the composition of the barrier fluid differs from the composition of the gas mixture present in the riser. In some embodiments, the amount of added barrier fluid is adjusted such that an upward flow of gas countercurrent to the flow of the polymer particles is generated and acts as a barrier to the gas mixture entrained among the particles coming from the riser. In some embodiments, the countercurrent occurs at the top of the riser unit. In some embodiments, two different gas composition zones are obtained in the multizone circulating reactor. In some embodiments, make-up monomers, comonomers, molecular weight regulators, or inert fluids are introduced at any point of the downcomer, alternatively below the barrier feeding point. In some embodiments, the molecular weight regulator is hydrogen. In some embodiments, varying monomer, comonomer, or hydrogen concentrations are created along the downcomer, thereby further differentiating the polymerization conditions.

In some embodiments, the process is carried out in two or more gas-phase polymerization reactors and includes a step of transferring the polymer particles from a first reactor to another reactor. In some embodiments, the antistatic agent is introduced directly into the transfer line, thereby avoiding agglomeration or clogging of the line.

In some embodiments, the fluidized-bed reactor is arranged upstream of the multizone circulating reactor. In some embodiments, a reactor cascade of gas-phase reactors includes additional polymerization reactors. In some embodiments, the additional reactors are low-pressure polymerization reactors. In some embodiments, the low-pressure polymerization reactors are gas-phase reactors or suspension reactors. In some embodiments, the additional reactors include a pre-polymerization stage.

In some embodiments, the process further includes the steps of:
feeding an olefin or an olefin and one or more other ethylenically unsaturated monomers into a gas-phase polymerization reactor, therein forming polymer particles;
transferring the polymer particles from a first gas-phase reactor to another gas-phase reactor; and
discharging the formed polyolefin particles from the gas-phase reactor.

In some embodiments, the antistatic agent is feed directly into the reactor or into a line leading to the reactor. In some embodiments, the gas velocity distributes the antistatic agent. In some embodiments, the mixture of polyolefin particles and gas is conveyed through the polymerization apparatus at a velocity of greater than or equal to 2 m/s, alternatively greater than or equal to 2.5 m/s.

In some embodiments, the manner of introducing the antistatic agent into the polymerization reactor varies depending on the polymer produced. In some embodiments and for polyethylene production, the antistatic agent is introduced into the polymerization reactor by a stream of a liquid carrier. In some instances, the stream of liquid carrier is referred to pick-up stream. In some embodiments, the stream of liquid carrier is a stream of liquid hydrocarbons. In some embodiments, the hydrocarbons have 3 to 8 carbons. In some embodiments, the hydrocarbons are propane. In some embodiments, the weight ratio of antistatic agent to liquid carrier in the combined stream, which is introduced into the reactor, is less than 1:5, alternatively in the range from 1:5000 to 1:10, alternatively in the range from 1:2000 to 1:20, alternatively in the range from 1:1000 to 1:50. In some embodiments, the combined feed stream is free of organoaluminum compounds such as aluminum alkyls. In some embodiments, the feed line for introducing the combined feed stream is equipped with a static mixer and the combined feed stream passes the static mixer before being introducing into the gas-phase polymerization reactor.

In some embodiments, the antistatic agent is introduced together with monomer, comonomer, or both stream.

In some embodiments, the polymerization is a gas-phase polymerization and the antistatic agent is introduced into the gas-phase polymerization reactor by feeding the antistatic agent to a part of the reactor where the density of solid polymer particles is at least 30 kg/m³, alternatively at least 50 kg/m³, alternatively at least 80 kg/m³. In some embodiments, the antistatic agent to parts of the gas-phase polymer reactors, which contain a stirred or fluidized bed of polymer particles. In some embodiments, the antistatic agent is fed into a riser or a downcomer of a multizone circulating reactor.

In some embodiments, the antistatic agent is fed to the polymerization reactor sand to the pipe conveying the mixture of polyolefin particles and gas. In some embodiments, the antistatic agent is fed at a velocity of greater than or equal to 2 m/s, alternatively greater than or equal to 2.5 m/s. In some embodiments, the pipe is a transfer line transferring the mixture from one polymerization reactor into a subsequent polymerization reactor or a discharge line. In some embodiments, the discharge line is for discharging the mixture into a collecting, degassing, or recovery vessel. Without being bound to any theory, it is believed that, in some instances, the high transport velocity of greater than or equal to 2 m/s increases the electrostatic loading of the polyolefin particles within the mixture. In some embodiments, additionally injecting antistatic agents into the pipe distributes the antistatic agent within the mixture, thereby (a) reducing the electrostatic loading of the polyolefin particles and (b) preventing wall sheeting and plugging within the pipe and at the section of the subsequent vessel, which comes into contact with the mixture being discharged from the pipe.

In some embodiments, the antistatic agent is made from or containing an alkylene oxide derived polymer. In some embodiments, the alkylene oxide derived polymer is made from or containing, in average, from 10 to 200 repeating units —(CH₂—CHR—O)— with R being hydrogen or an alkyl group having from 1 to 6 carbon atoms, wherein the alkylene oxide derived polymer is a random copolymer of ethylene oxide and other alkylene oxides and a ratio n:m of repeating units —(CH₂—CH₂—O)— derived from ethylene oxide to repeating units —(CH₂—CHR′—O)— derived from the other alkylene oxides with R′ being an alkyl group having from 1 to 6 carbon atoms is in the range of from 6:1 to 1:1, and the end groups of the alkylene oxide derived polymer are —OH groups.

In some embodiments, the alkylene oxide derived polymer is a random copolymer of ethylene oxide and propylene oxide. In some embodiments, the alkylene oxide derived polymer is a linear ethylene oxide/propylene oxide copolymer.

In some embodiments, the polymerization is carried out in a cascade of a fluidized-bed reactor and a multizone circulating reactor and the polymerization reactors are operated with different polymerization conditions. In some embodiments, the polymerization reactors are operated with different concentrations of molecular weight regulator such as hydrogen. In some embodiments, a lower molecular weight polyolefin polymer component is obtained in the polymerization with the higher hydrogen concentration reactor. In some embodiments, a higher molecular weight polyolefin polymer component is obtained in the polymerization with the lower hydrogen concentration reactor. In some embodiments, a lower molecular weight polyolefin polymer component is obtained in the fluidized-bed reactor and a higher molecular weight polyolefin polymer component is obtained in the multizone circulating reactor. In some embodiments, the fluidized-bed reactor is operated with a higher concentration of hydrogen, thereby producing a lower molecular weight polyolefin polymer component. In some embodiments, the multizone circulating reactor is operated with a lower concentration of hydrogen, thereby producing a higher molecular weight polyolefin polymer component. In some embodiments, the resulting polyolefin polymers are polyethylenes having a MFR_{21.6} according to DIN EN ISO 1133:2005 at a temperature of 190° C. under a load of 21.6 kg in the range of from 0.5 g/10 min to 350 g/10 min, alternatively in the range of from 1.0 g/10 min to 40 g/10 min, alternatively in the range from 120 g/10 min to 250 g/10 min. In some embodiments, the resulting polyolefin polymers are polyethylenes having a MFR_{21.6} in the range of from 1.2 g/10 min to 35 g/10 min, alternatively from 1.5 g/10 min to 10 g/10 min. In some embodiments, the density is in the range of from 0.935 g/cm³ to 0.970 g/cm³. In some embodiments, the density is in the range of from 0.945 g/cm³ to 0.968 g/cm³.

In some embodiments, the process is for the homopolymerization of ethylene or copolymerization of ethylene and up to 20 wt.-% of C₃-C₈-1-alkenes.

In some embodiments, the process is for preparing polyethylenes in a polymerization reactor cascade, wherein a fluidized-bed reactor is arranged upstream of a multizone circulating reactor and an ethylene homopolymer or ethylene copolymer, which has a MFR_{2.16} according to DIN EN ISO 1133:2005 at a temperature of 190° C. under a load of 2.16 kg in the range of from 0.1 g/10 min to 300 g/10 min, alternatively from 1 g/10 min to 100 g/10 min, is produced in the fluidized-bed reactor.

In some embodiments, the process is for preparing a polyolefin polymer by gas-phase polymerization in a polymerization reactor cascade including a fluidized-bed reactor and a multizone circulating reactor, wherein the formation of polymer agglomerates in the polymerization reactors and fluctuations in the fluid-dynamics of the multizone circulating reactor are prevented or at least reduced.

In some embodiments, the present disclosure provides a gas-phase polymerization apparatus for carrying out the process, wherein the gas-phase polymerization reactor includes a gas-phase polymerization reactor and at least one pipe, equipped with at least one inlet for introducing an antistatic agent into the pipe.

In some embodiments, the pipe has a receiving end for receiving a mixture of polyolefin particles and gas and a discharge end for discharging a mixture of polyolefin particles and gas, wherein the inlet is within the first half, alternatively within the first third, of the pipe from the receiving end of the pipe. Without being bound to any theory, it is believed that the distance between the receiving end and the inlet affects distribution of the antistatic agent on the polymer particles, thereby resulting in reduced wall sheeting and agglomeration of the polymer particles.

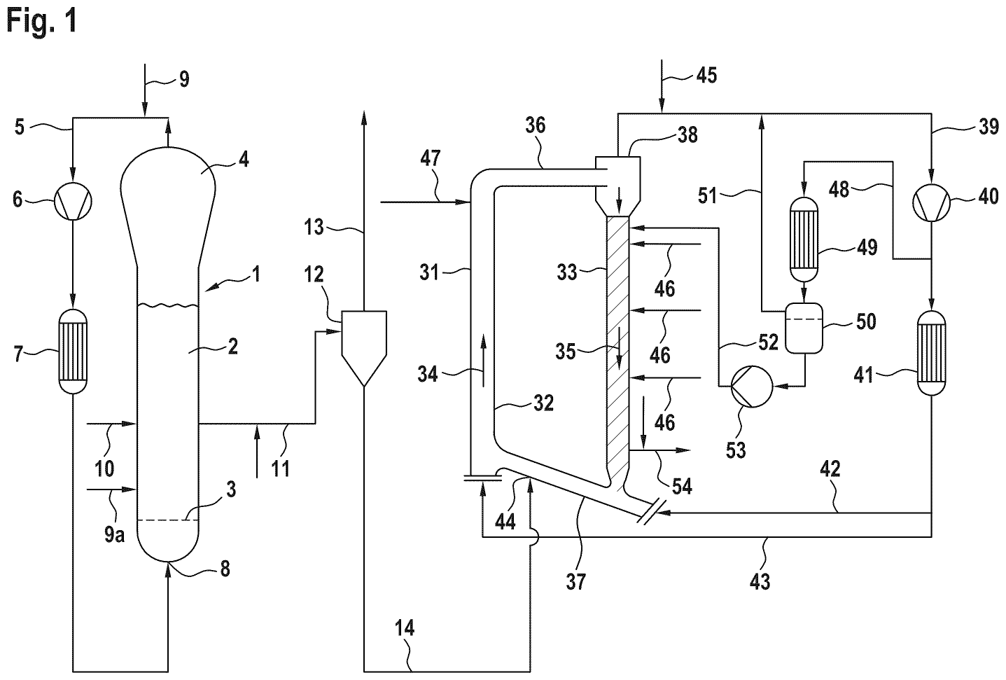

The present disclosure will be described in more detail with reference to FIG. 1, without being understood as limiting the scope and spirit of the present disclosure.

FIG. 1 shows a schematic of a polymerization reactor cascade including a fluidized-bed reactor and a multizone circulating reactor, wherein the arrows depict points of introduction for the antistatic agent.

The first gas-phase reactor, fluidized-bed reactor (1), includes a fluidized bed (2) of polyolefin particles, a gas distribution grid (3), and a velocity reduction zone (4). In some embodiments, the velocity reduction zone (4) is of increased diameter compared to the diameter of the fluidized-bed portion of the reactor. An upwardly flow of gas fed through the gas distribution grid (3), placed at the bottom portion of the reactor (1), keeps the polyolefin bed in a fluidized state. The gaseous stream of the reaction gas leaving the top of the velocity reduction zone (4) via recycle line (5) is compressed by compressor (6), transferred to a heat exchanger (7), wherein the stream is cooled, and then recycled to the bottom of the fluidized-bed reactor (1) at a point below the gas distribution grid (3) at position (8). In some embodiments, the recycle gas is cooled to below the dew point of one or more of the recycle gas components in the heat exchanger, thereby operating the reactor with condensed material, that is, in the condensing mode. In some embodiments, the recycle gas is made from or containing unreacted monomers, inert condensable gases, and inert non-condensable gases. In some embodiments, the inert condensable gases are alkanes. In some embodiments, the inert non-condensable gas is nitrogen. In some embodiments, make-up monomers, molecular weight regulators, optional inert gases, or process additives are fed into the reactor (1) at various positions, alternatively via one or more lines (9) into recycle line (5) upstream of the compressor (6) or via line (9a) to the polymer bed within fluidized-bed reactor (1). In some embodiments, the catalyst is fed into the reactor (1) via a line (10). In some embodiments, line (10) is placed in the lower part of the fluidized bed (2).

The polyolefin particles obtained in fluidized-bed reactor (1) are discontinuously discharged via line (11) and fed to a solid/gas separator (12), thereby avoiding the gaseous mixture, coming from fluidized-bed reactor (1), entering the second gas-phase reactor. In some embodiments, line (11) is the point of introducing the antistatic agent. The gas leaving solid/gas separator (12) exits the reactor via line (13) as off-gas while the separated polyolefin particles are fed via line (14) to the second gas-phase reactor.

The second gas-phase reactor is a multizone circulating gas-phase reactor (31) including two reaction zones, a riser (32) and a downcomer (33), which are repeatedly passed by the polyolefin particles. Within riser (32), the polyolefin particles flow upward under fast fluidization conditions along the direction of arrow (34). Within downcomer (33), the polyolefin particles flow downward under the action of gravity along the direction of arrow (35). The riser (32) and the downcomer (33) are interconnected by the interconnection bends (36) and (37).

After flowing through the riser (32), the polyolefin particles and the gaseous mixture leave the riser (32) and are conveyed to a solid/gas separation zone (38). In some embodiments, the solid/gas separation is effected by a centrifugal separator like a cyclone. From the separation zone (38), the polyolefin particles enter the downcomer (33).

The gaseous mixture leaving the separation zone (38) is recycled to the riser (32) via a recycle line (39), equipped with a compressor (40) and a heat exchanger (41). Downstream of the heat exchanger (41), the recycle line (39) splits. The gaseous mixture is divided into two streams: line (42) conveys a first part of the recycle gas into the interconnection bend (37) while the line (43) conveys a second part of the recycle gas to the bottom of the riser (32), thereby establishing fast fluidization conditions therein. The polyolefin particles coming from the first gas-phase reactor via line (14) enter the multizone circulating gas-phase reactor (31) at the interconnection bend (37) in position (44).

In some embodiments, make-up monomers, make-up comonomers, and optionally inert gases or process additives are fed to the multizone circulating reactor (31) via one, two or more lines (45) or (46), placed at a point of the gas recycle line (39) or the downcomer (33). In some embodiments, process additives such as antistatic agents are fed via line (47).

A first part of the gaseous mixture leaving the separation zone (38) exits recycle line (39) after the compressor (40) and is sent through line (48) to heat exchanger (49), where the first part of the mixture is cooled to a temperature at which the monomers and the optional inert gas are partially condensed. A separating vessel (50) is placed downstream the heat exchanger (49). The separated gaseous mixture is recirculated through line (51) to recycle line (39), and the separated liquid is fed to the downcomer (33) through line (52) by pump (53).

In some embodiments, the polyolefin particles obtained in the multizone circulating reactor (31) are continuously discharged from the bottom part of downcomer (33) via discharge line (54). In some embodiments, discharge line (54) is a point of introducing the antistatic agent.

In some embodiments and by choosing discharge lines (11), (54), or both as point(s) of introducing the antistatic agent in combination with conveying the mixture of polyolefin particles and gas with a velocity greater than or equal to 2 m/s, formation of wall sheeting and polymer agglomerates is avoided without affecting the operability of the polymerization process.

1. A process for the continuous production of a polyolefin polymer in a gas-phase polymerization apparatus at temperatures from 20 to 200° C. and pressures from 0.5 to 10 MPa in the presence of a polymerization catalyst, comprising the steps of:
providing a mixture of polyolefin particles and gas;
conveying the mixture through a pipe at a gas velocity of greater than or equal to 2 m/s; and
introducing an antistatic agent into the mixture.

2. The process according to claim 1, wherein the density of the polyolefin particles in the gas is at least 30 kg/m³.

3. The process according to claim 1, wherein the pipe is a discharge line, a transfer line, or both.

4. The process according to claim 1, further comprising the steps of:
feeding an olefin or an olefin and one or more other ethylenically unsaturated monomers into a gas-phase polymerization reactor;
homopolymerizing the olefin or copolymerizing the olefin and the one or more other ethylenically unsaturated monomer in the gas-phase reactor in the presence of a polymerization catalyst, thereby forming polyolefin particles; and
discharging the formed polyolefin particles from the gas-phase reactor.

5. The process according to claim 1, wherein the gas-phase polymerization apparatus comprises two or more gas-phase polymerization reactors.

6. The process according to claim 1, wherein the antistatic agent comprises an alkylene oxide derived polymer

7. The process of claim 6, wherein the alkylene oxide derived polymer is a random copolymer of ethylene oxide and propylene oxide.

8. The process according to claim 1, wherein the antistatic agent is introduced into the mixture of gas and polyolefin in a feed of a liquid carrier.

9. The process of claim 8, wherein the liquid carrier is selected from the group consisting of water and liquid hydrocarbons.

10. The process according to claim 1, wherein the polymerization is carried out in a polymerization reactor cascade comprising a fluidized-bed reactor and a multizone circulating reactor, wherein, in the multizone circulating reactor, the growing polymer particles flow upward through a first polymerization zone under fast fluidization or transport conditions, leave the first polymerization zone, enter a second polymerization zone through which the particles flow downward under the action of gravity, leave the second polymerization zone, and are reintroduced into the first polymerization zone, thereby establishing a circulation of polymer, and wherein the fluidized-bed reactor is arranged upstream of the multizone circulating reactor.

11. The process of claim 10, wherein a comparatively lower molecular weight polyolefin polymer component is obtained in the fluidized-bed reactor and a comparatively higher molecular weight polyolefin polymer component is obtained in the multizone circulating reactor.

12. The process according to claim 1, wherein the polyolefin polymer is a polyethylene prepared by homopolymerizing ethylene or copolymerizing ethylene and up to 10 wt. % of C₃-C₈-1-alkenes.

13. The process according to claim 1, wherein the antistatic agent is fed into at least one gas-phase polymerization reactor and fed into the pipe conveying the mixture at a gas velocity of greater than or equal to 2 m/s.
